(19) United States
(12) Patent Application Publication
(10) Pub. No.: US 2024/0177035 A1
(43) Pub. Date: May 30, 2024

(54) QUANTUM SYSTEM VIEW VIA GATEWAY MECHANISMS

(71) Applicant: Red Hat, Inc., Raleigh, NC (US)

(72) Inventors: Leigh Griffin, Waterford (IE); Stephen Coady, Waterford (IE)

(21) Appl. No.: 18/071,279

(22) Filed: Nov. 29, 2022

(51) Int. Cl. G06N 10/20

(52) U.S. Cl. CPC G06N 10/20

(57) ABSTRACT

A first quantum computing system (QCS) receives from a client computing device a quantum instruction file (QIF). The first QCS accesses a list of resources that identifies resources available on a second QCS and a list of resources that identifies resources available on a third QCS. The first QCS generates, based on the QIF, a representative QCS comprising a subset of the resources available on the second QCS and a subset of the resources available on the third QCS. The first QCS executes a first portion of the QIF on the second QCS to utilize the subset of the resources available on the second QCS and a second portion of the QIF on the third QCS to utilize the subset of the resources available on the third QCS. The first QCS returns to the client computing device a response from the execution of the QIF.

### BACKGROUND

Quantum computing involves the use of quantum bits, referred to herein as “qubits,” which have characteristics that differ from those of classical (i.e., non-quantum) bits used in classical computing. Qubits may be employed by quantum services that are executed by quantum computing devices. As quantum computing continues to increase in popularity and become more commonplace, an ability to efficiently and accurately allocate qubits in real time will be desirable.

### SUMMARY

The examples disclosed herein implement a quantum service gateway that performs quantum system view via gateway mechanisms. In particular, the quantum service gateway can create a representative quantum computing system based on instructions from a quantum computing device. The quantum service gateway can find available resources of quantum computing systems that can execute the instructions, abstract those resources, and present the representative quantum computing system with the available resources to the quantum computing device. The quantum computing device can interact with the quantum service gateway to view the representative quantum computing system and use the resources of the quantum computing systems within the representative quantum computing system.

In one example, a method for quantum system view via gateway mechanisms is disclosed. The method includes receiving, by a first quantum computing system from a client computing device, a quantum instruction file. The method further includes accessing, by the first quantum computing system, a list of resources that identifies resources available on a second quantum computing system and a list of resources that identifies resources available on a third quantum computing system. The method further includes generating, by the first quantum computing system based on the quantum instruction file, a representative quantum computing system comprising a subset of the resources available on the second quantum computing system and a subset of the resources available on the third quantum computing system. The method further includes executing, by the first quantum computing system, a first portion of the quantum instruction file on the second quantum computing system to utilize the subset of the resources available on the second quantum computing system and a second portion of the quantum instruction file on the third quantum computing system to utilize the subset of the resources available on the third quantum computing system. The method further includes returning, by the first quantum computing system to the client computing device, a response from the execution of the quantum instruction file.

In another example, a quantum computing device for quantum system view via gateway mechanisms is disclosed. The quantum computing device comprises a system memory, and a processor device communicatively coupled to the system memory. The processor device is to receive a quantum instruction file from a client computing device. The processor device is further to communicate with quantum computing devices in other quantum computing systems. The processor device is further to generate a representative quantum computing system comprising a subset of resources available on the other quantum computing systems based on the quantum instruction file.

In another example, a non-transitory computer-readable storage medium is disclosed. The non-transitory computer-readable storage medium stores thereon computer-executable instructions that, when executed, cause one or more processor devices to receive a quantum instruction file from a client computing device. The instructions further cause the processor device to access a list of resources that identifies resources available on a second quantum computing system and a list of resources that identifies resources available on a third quantum computing system. The instructions further cause the processor device to generate a representative quantum computing system comprising a subset of the resources available on the second quantum computing system and a subset of the resources available on the third quantum computing system.

Individuals will appreciate the scope of the disclosure and realize additional aspects thereof after reading the following detailed description of the examples in association with the accompanying drawing figures.

### BRIEF DESCRIPTION OF THE DRAWINGS

The accompanying drawing figures incorporated in and forming a part of this specification illustrate several aspects of the disclosure and, together with the description, serve to explain the principles of the disclosure.

FIG. 1 is a block diagram of an environment in which examples of quantum system view via gateway mechanisms may be practiced;

FIG. 2 is a flowchart illustrating operations performed by a quantum computing device to implement quantum system view via gateway mechanisms, according to one example;

FIG. 3 is a block diagram of the environment illustrated in FIG. 1 for quantum system view via gateway mechanisms, according to another example;

FIG. 4 is a block diagram of the environment illustrated in FIG. 1 for quantum system view via gateway mechanisms, according to another example;

FIG. 5 is a block diagram of the environment illustrated in FIG. 1 for quantum system view via gateway mechanisms, according to another example;

FIG. 6 is a block diagram of the environment illustrated in FIG. 1 for quantum system view via gateway mechanisms, according to another example;

FIG. 7 is a block diagram of a quantum computing device suitable for implementing aspects illustrated in FIGS. 1-6 according to one example;

FIG. 8 is a block diagram of the quantum computing device according to additional examples;

FIG. 9 is a flowchart illustrating operations performed by the quantum computing device of FIG. 1 for quantum system view via gateway mechanisms, according to one example;

FIG. 10 is a simpler block diagram of the quantum computing device of FIG. 1 for quantum system view via gateway mechanisms, according to one example; and

FIG. 11 is a block diagram of a quantum computing device suitable for implementing examples, according to one example.

### DETAILED DESCRIPTION

The examples set forth below represent the information to enable individuals to practice the examples and illustrate the best mode of practicing the examples. Upon reading the following description in light of the accompanying drawing figures, individuals will understand the concepts of the disclosure and will recognize applications of these concepts not particularly addressed herein. It should be understood that these concepts and applications fall within the scope of the disclosure and the accompanying claims.

Any flowcharts discussed herein are necessarily discussed in some sequence for purposes of illustration, but unless otherwise explicitly indicated, the examples are not limited to any particular sequence of steps. The use herein of ordinals in conjunction with an element is solely for distinguishing what might otherwise be similar or identical labels, such as “first executing quantum service” and “second executing quantum service,” and does not imply a priority, a type, an importance, or other attribute, unless otherwise stated herein. The term “about” used herein in conjunction with a numeric value means any value that is within a range of ten percent greater than or ten percent less than the numeric value. As used herein and in the claims, the articles “a” and “an” in reference to an element refers to “one or more” of the elements unless otherwise explicitly specified. The word “or” as used herein and in the claims is inclusive unless contextually impossible. As an example, the recitation of A or B means A, or B, or both A and B.

Quantum computing involves the use of quantum bits, referred to herein as “qubits,” which have characteristics that differ from those of classical (i.e., non-quantum) bits used in classical computing. Qubits may be employed by quantum services that are executed by quantum computing devices.

Obtaining access to computing resources in a quantum computing system can be expensive in terms of computing resources. A client computing device that requires particular computing resources may need to locate a quantum computing system that the client computing device can run on. However, there may be a long lead time before the client computing device can obtain access to the resources in the quantum computing system, disrupting workflow and decreasing productivity.

The quantum service gateway can allow client computing devices or requesting services to obtain access to computing resources in a quantum computing system without disrupting workflow. The quantum service gateway can receive instructions from the client computing device that detail the particular computing resources required for the client computing device to run. The quantum service gateway can interrogate existing quantum hardware in multiple quantum computing systems to ensure resources of the quantum computing systems are available for the client computing device, and determine the quantum hardware in the quantum computing systems that can be combined to execute the instructions from the client computing device. The resources and quantum hardware that can be combined to successfully execute the instructions can be viewed by the client computing device as a representative quantum computing system. As a result, the quantum service gateway can act as a gateway mechanism to allow the instructions of the client computing device to be executed using the resources and quantum hardware of the quantum computing systems that comprise the representative quantum computing system, reducing computing time and minimizing the resource hit on each quantum computing system. As the scale or number of quantum computing systems increases, the computing resource hit on each quantum computing system can be minimized.

The quantum service gateway can execute a first portion of the instructions received from the client computing device on one quantum computing system that comprises the representative quantum computing system and a second portion of the instructions on a second quantum computing system that comprises the representative quantum computing system. The first portion of the instructions can use the resources and quantum hardware of the first quantum computing system and the second portion of the instructions can use the resources and hardware of the second quantum computing system. The client computing device may be unaware that a portion of the instructions were executed on one quantum computing system to use that quantum computing system's resources and quantum hardware and that another portion of the instructions were executed on another quantum computing system to use that quantum computing system's resources and quantum hardware.

An interface can be provided by the quantum service gateway to the client computing device in order for the client computing device to run a quantum service in the representative quantum computing system. The quantum service gateway can access the resources and quantum hardware of the quantum computing systems that comprise the representative quantum computing system in order to run the quantum service. The client computing device may be unaware that the resources and quantum hardware utilized to run the quantum service come from the one or more quantum computing systems that comprise the representative quantum computing system.

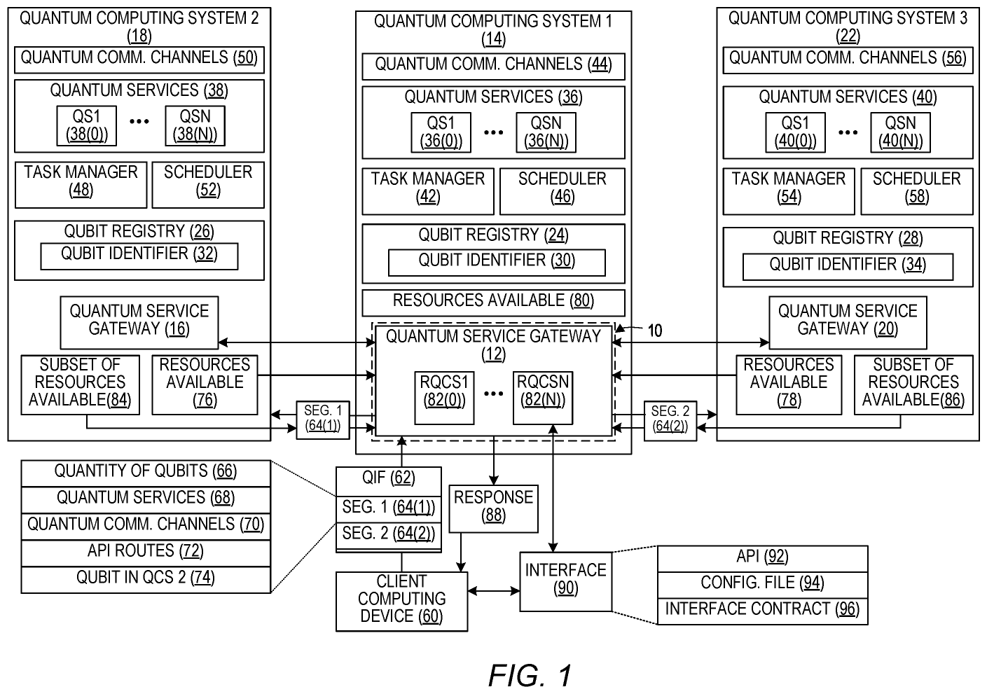

FIG. 1 is a block diagram of a quantum computing device 10 that comprises a system memory, a processor device, and a storage device, in which examples of a quantum service gateway may be practiced. It is to be understood that the quantum computing device 10 in some examples may include constituent elements in addition to those illustrated in FIG. 1. In the example of FIG. 1, the quantum computing device 10 implements a quantum service gateway 12 that performs quantum system view via gateway mechanisms.

The quantum computing device 10 that implements the quantum service gateway 12 may run on a first quantum computing system 14. The quantum service gateway 12 may communicate with a quantum service gateway 16 in a second quantum computing system 18 and a quantum service gateway 20 in a third quantum computing system 22. The quantum service gateways (e.g., 12, 16, 20) may be in continuous communication with each other in order to recognize the resources of each quantum computing system (e.g., 14, 18, 22). Each quantum computing system (e.g., 14, 18, 22) may comprise a quantum computing machine that includes computing resources and quantum hardware.

In the example of FIG. 1, the first quantum computing system 14, the second quantum computing system 18, and the third quantum computing system 22 each implement a set of one or more qubits (not shown). To maintain information for the qubit(s), the first quantum computing system 14 includes a qubit registry 24, the second quantum computing system 18 includes a qubit registry 26, and the third quantum computing system 22 includes a qubit registry 28. Each qubit registry comprises a plurality of qubit registry entries (not shown) each corresponding to a qubit such as the one or more qubits. The qubit registry 24 maintains and provides access to data relating to the qubits implemented by the first quantum computing system 14, such as a count of the total number of qubits implemented by the first quantum computing system 14 and a count of the number of available qubits that are currently available for allocation, as non-limiting examples. The qubit registry 26 maintains and provides access to data relating to the qubits implemented by the second quantum computing system 18, such as a count of the total number of qubits implemented by the second quantum computing system 18 and a count of the number of available qubits that are currently available for allocation, as non-limiting examples. The qubit registry 28 maintains and provides access to data relating to the qubits implemented by the third quantum computing system 22, such as a count of the total number of qubits implemented by the third quantum computing system 22 and a count of the number of available qubits that are currently available for allocation, as non-limiting examples.

Each of the qubit registry entries of the qubit registry 24, the qubit registry 26, and the qubit registry 28 also store qubit metadata (not shown) for a corresponding qubit. The qubit metadata may include, as non-limiting examples, a qubit identifier, an availability indicator that indicates whether the corresponding qubit is available for use or is in use by a specific quantum service, an identifier of a quantum service that is associated with the corresponding qubit or to which the corresponding qubit is allocated, and/or an quantum phenomena indicator that indicates whether the corresponding qubit is in an entangled state and/or a superposition state. For example, the qubit registry 24 in the first quantum computing system 14 may include a qubit identifier 30 in the qubit metadata, the qubit registry 26 in the second quantum computing system 18 may include a qubit identifier 32 in the qubit metadata, and the qubit registry 28 in the third quantum computing system 22 may include a qubit identifier 34 in the qubit metadata.

The first quantum computing system 14 of FIG. 1 executes one or more quantum services 36, such as one or more of quantum services 36(0)-36(N). The quantum services 36 are processes that employ qubits such as the one or more qubits to provide desired functionality. The second quantum computing system 18 executes one or more quantum services 38, such as one or more quantum services 38(0)-38(N). The quantum services 38 are processes that employ qubits such as the one or more qubits to provide desired functionality. The third quantum computing system 22 executes one or more quantum services 40, such as one or more of quantum services 40(0)-40(N). The quantum services 40 are processes that employ qubits such as the one or more qubits to provide desired functionality.

The first quantum computing system 14 may include a task manager 42. The task manager 42 may monitor utilization of the resources and quantum hardware of the first quantum computing system 14, such as the quantum services 36, the qubit registry 24, qubits such as the one or more qubits, and a quantum communication channel 44. The first quantum computing system 14 may also include a scheduler 46. The scheduler 46 can start or stop one or more quantum services of the quantum services 36 of the first quantum computing system 14. The scheduler 46 may be a quantum service, such as one of the quantum services 36.

Similarly, the second quantum computing system 18 may include a task manager 48. The task manager 48 may monitor utilization of the resources and quantum hardware of the second quantum computing system 18, such as the quantum services 38, the qubit registry 26, qubits such as the one or more qubits, and a quantum communication channel 50. The second quantum computing system 18 may also include a scheduler 52. The scheduler 52 can start or stop one or more quantum services of the quantum services 38 of the second quantum computing system 18. The scheduler 52 may be a quantum service, such as one of the quantum services 38.

The third quantum computing system 22 may also include a task manager 54. The task manager 54 may monitor utilization of the resources and quantum hardware of the third quantum computing system 22, such as the quantum services 40, the qubit registry 28, qubits such as the one or more qubits, and a quantum communication channel 56. The third quantum computing system 22 may also include a scheduler 58. The scheduler 58 can start or stop one or more quantum services of the quantum services 40 of the third quantum computing system 22. The scheduler 58 may be a quantum service, such as one of the quantum services 40.

The first quantum computing system 14 may be in a different location from the second quantum computing system 18. The first quantum computing system 14 may be in a different location from the third quantum computing system 22. The second quantum computing system 18 may be in a different location from the third quantum computing system 22. The first quantum computing system 14 may be in the same location as the second quantum computing system 18 and the third quantum computing system 22. The first quantum computing system 14 may be in the same location as the second quantum computing system 18 and a different location from the third quantum computing system 22. The first quantum computing system 14 may be in the same location as the third quantum computing system 22 and a different location from the second quantum computing system 18.

In the example of FIG. 1, a client computing device 60 sends requests to a quantum service to execute instructions in a quantum computing system. For example, the client computing device 60 may send a quantum instruction file 62 to the quantum service gateway 12 on the first quantum computing system 14. In the example of FIG. 1, the quantum service gateway 12 sits in the first quantum computing system 14 and performs operations by the first quantum computing system 14. It is to be understood that the quantum service gateway 12 in some examples may sit in another quantum computing system, such as the second quantum computing system 18 to perform operations by the second quantum computing system 18 or the third quantum computing system 22 to perform operations by the third quantum computing system 22.

The quantum service gateway 12 may receive the quantum instruction file 62 from the client computing device 60. The quantum instruction file 62 may comprise a list of instructions that can be executed on a quantum computing device in a quantum computing system (e.g., 14, 18, 22). The quantum instruction file 62 may be a Quantum Assembly (QASM) file or any other component that contains a list of instructions that can be executed on a quantum computing device in a quantum computing system (e.g., 14, 18, 22). The quantum instruction file 62 may be created by a user of the client computing device 60 or by a quantum service in one or more of the quantum computing systems (e.g., 36, 38, 40) may create the quantum instruction file 62. The quantum instruction file 62 may contain segments of instructions to be executed on a quantum computing device in a quantum computing system, such as a first segment 64(1) and a second segment 64(2). In one example, the first segment 64(1) and the second segment 64(2) may be executed in the same quantum computing system. The first segment 64(1) and the second segment 64(2) may be executed together or individually when executed in the same quantum computing system. In another example, the first segment 64(1) and the second segment 64(2) may be executed on different quantum computing systems.

The list of instructions in the quantum instruction file 62 may comprise information about the computing resources required for the client computing device 60 to run in a quantum computing system (e.g., 14, 18, 22) and thus describes the ecosystem of the quantum computing system that the client computing device 60 wants to execute on. For example, the list of instructions in the quantum instruction file 62 may contain computing resources, such as one or more of a quantity of qubits 66, quantum services 68, quantum communication channels 70, and application programming interface (API) routes 72, as non-limiting examples, that the client computing device 60 requires to run in a quantum computing system (e.g., 14, 18, 22). The list of instructions in the quantum instruction file 62 may contain one or more instructions that are predefined for a qubit in a quantum computing system (e.g., 14, 18, 22). For example, the list of instructions in the quantum instruction file 62 may contain an instruction that is predefined for a qubit in the second quantum computing system 74, so that instruction from the quantum instruction file 62 should go to the second quantum computing system 18.

The quantum service gateway 12 may access a list of resources available 76 on the second quantum computing system 18. The list of resources available 76 on the second quantum computing system 18 may comprise computing resources, such as a quantity of qubits, quantum services, quantum communication channels, and API routes, as non-limiting examples, of the second quantum computing system 18 that are available for use by the client computing device 60. In some examples, the computing resources in the list of resources available 76 on the second quantum computing system 18 may correspond to the computing resources in the list of instructions in the quantum instruction file 62 that includes information about the computing resources required for the client computing device 60 to run in a quantum computing system.

The quantum service gateway 12 may access a list of resources available 78 on the third quantum computing system 22. The list of resources available 78 on the third quantum computing system 22 may comprise computing resources, such as a quantity of qubits, quantum services, quantum communication channels, and API routes, as non-limiting examples, of the third quantum computing system 22 that are available for use by the client computing device 60. In some examples, the computing resources in the list of resources available 78 on the third quantum computing system 22 may correspond to the computing resources in the list of instructions in the quantum instruction file 62 that includes information about the computing resources required for the client computing device 60 to run in a quantum computing system.

The quantum service gateway 12 may access a list of resources available 80 on the first quantum computing system 14. The list of resources available 80 on the first quantum computing system 14 may comprise computing resources, such as a quantity of qubits, quantum services, quantum communication channels, and API routes, as non-limiting examples, of the first quantum computing system 14 that are available for use by the client computing device 60. In some examples, the computing resources in the list of resources available 80 on the first quantum computing system 14 may correspond to the computing resources in the list of instructions in the quantum instruction file 62 that includes information about the computing resources required for the client computing device 60 to run in a quantum computing system.

The quantum service gateway 12 may generate a representative quantum computing system 82(0) based on the quantum instruction file 62. The representative quantum computing system 82(0) may comprise a subset of the resources available 84 on the second quantum computing system 18 and a subset of the resources available 86 on the third quantum computing system 22. In some examples, the representative quantum computing system 82(0) may comprise the subset of the resources available 84 on the second quantum computing system 18. In another example, the representative quantum computing system 82(0) may comprise the subset of the resources available 86 on the third quantum computing system 22. The subset of the resources available 84 on the second quantum computing system 18 that comprise the representative quantum computing system 82(0) may include computing resources in the list of instructions in the quantum instruction file 62. For example, the subset of the resources available 84 on the second quantum computing system 18 may correspond to the computing resources identified in the first segment 64(1) of the quantum instruction file 62. The subset of resources available 86 on the third quantum computing system 22 that comprise the representative quantum computing system 82(0) may include computing resources in the list of instructions in the quantum instruction file 62. For example, the subset of resources available 86 on the third quantum computing system 22 may correspond to the computing resources identified in the second segment 64(2) of the quantum instruction file 62.

In addition to the representative quantum computing system 82(0), the quantum service gateway 12 may generate additional representative quantum computing systems, such as representative quantum computing system 82(N), based on the quantum instruction file 62. The representative quantum computing system 82(N) may comprise the subset of the resources available 84 on the second quantum computing system 18 and the subset of the resources available 86 on the third quantum computing system 22. In some examples, the representative quantum computing system 82(N) may comprise the resources available 76 on the second quantum computing system 18 or the subset of the resources available 84 on the second quantum computing system 18. In another example, the representative quantum computing system 82(N) may comprise the resources available 78 or the subset of the resources available 86 on the third quantum computing system 22. In other examples, the representative quantum computing system 82(N) may comprise the resources available 80 on the first quantum computing system 14 or a subset of the resources available on the first quantum computing system 14.

The quantum service gateway 12 can execute the first segment 64(1) of the quantum instruction file 62 on the second quantum computing system 18 to utilize the subset of resources available 84 on the second quantum computing system 18 and execute the second segment 64(2) of the quantum instruction file 62 on the third quantum computing system 22 to utilize the subset of resources available 86 on the third quantum computing system 22. In some examples, the quantum service gateway 12 can execute the list of instructions in the quantum instruction file 62 on the second quantum computing system 18 to utilize the resources available 76 or the subset of resources available 84 on the second quantum computing system 18. In another example, the quantum service gateway 12 can execute the list of instructions in the quantum instruction file 62 on the third quantum computing system 22 to utilize the resources available 78 or the subset of resources available 86 on the third quantum computing system 22.

The representative quantum computing system 82(0)-82(N) may abstract the computing resources in the subset of the resources available 84 on the second quantum computing system 18 and the computing resources in the subset of the resources available 86 on the third quantum computing system 22, and present the computing resources to the client computing device 60 as if the computing resources belong to one quantum computing system. As a result, the client computing device 60 may be unaware that the request from the client computing device 60 ran on more than one quantum computing system or which quantum computing system (e.g., 14, 18, 22) the computing resources utilized reside on. For example, the client computing device 60 may be unaware of the execution of the first segment 64(1) of the quantum instruction file 62 on the second quantum computing system 18 to utilize the subset of resources available 84 on the second quantum computing system 18 and the execution of the second segment 64(2) of the quantum instruction file 62 on the third quantum computing system 22 to utilize the subset of resources available 86 on the third quantum computing system 22. In examples where the quantum service gateway 12 executes the list of instructions in the quantum instruction file 62 on the second quantum computing system 18 to utilize the resources available 76 or the subset of resources available 84 on the second quantum computing system 18, the client computing device 60 may be unaware that the quantum instruction file 62 was executed on the second quantum computing system 18 to utilize the resources available 76 or the subset of resources available 84 on the second quantum computing system 18. In examples where the quantum service gateway 12 executes the list of instructions in the quantum instruction file 62 on the third quantum computing system 22 to utilize the resources available 78 or the subset of resources available 86 on the third quantum computing system 22, the client computing device 60 may be unaware that the quantum instruction file 62 was executed on the third quantum computing system 22 to utilize the resources available 78 or the subset of resources available 86 on the third quantum computing system 22.

The quantum service gateway 12 may access one or more of the qubit registry 26, the quantum services 38, the quantum communication channels 50, the scheduler 52, and the task manager 48 of the second quantum computing system 18. For example, when the quantum service gateway 12 executes the first segment 64(1) of the quantum instruction file 62 on the second quantum computing system 18 to utilize the subset of resources available 84 on the second quantum computing system 18, the quantum service gateway 12 may access the scheduler 52 and the task manager 48 of the second quantum computing system 18 to assign the subset of resources available 84 or to start or stop one or more quantum services of the quantum services 38.

The quantum service gateway 12 may access one or more of the qubit registry 28, the quantum services 40, the quantum communication channels 56, the scheduler 58, and the task manager 54 of the third quantum computing system 22. For example, when the quantum service gateway 12 executes the second segment 64(2) of the quantum instruction file 62 on the third quantum computing system 22 to utilize the subset of resources available 86 on the third quantum computing system 22, the quantum service gateway 12 may access the scheduler 58 and the task manager 54 of the third quantum computing system 22 to assign the subset of resources available 86 or to start or stop one or more quantum services of the quantum services 40.

The quantum service gateway 12 may access one or more of the qubit registry 24, the quantum services 36, the quantum communication channels 44, the scheduler 46, and the task manager 42 of the first quantum computing system 14. For example, when the quantum service gateway 12 executes the quantum instruction file 62 on the first quantum computing system 14 to utilize the resources available 80 or a subset of resources available on the first quantum computing system 14, the quantum service gateway 12 may access the scheduler 46 and the task manager 42 of the first quantum computing system 14 to assign the resources available 80 or the subset of resources available or to start or stop one or more quantum services of the quantum services 36.

The quantum service gateway 12 may return a response 88 from the execution of the quantum instruction file 62 to the client computing device 60. Subsequent to returning the response 88 to the client computing device 60, the client computing device 60 may utilize an interface 90 to access quantum computing systems (e.g., 14, 18, 22) to run a quantum service via the representative quantum computing system 82(0)-82(N). The interface 90 may comprise one or more of an API 92, a configuration file 94, or an interface contract 96. The quantum service gateway 12 may provide the client computing device 60 with access to resources of one or more quantum computing systems (e.g., 14, 18, 22) that comprise the representative quantum computing system 82(0)-82(N) through the interface 90 to the representative quantum computing system 82(0)-82(N). For example, the client computing device 60 may call the API 92 in order to run a quantum service and access the computing resources that comprise the representative quantum computing system 82(0)-82(N), such as the subset of resources available 84 on the second quantum computing system 18 and the subset of resources available 86 on the third quantum computing system 22. The quantum service may then access one or more of the qubit registry 26, the quantum services 38, the quantum communication channels 50, the scheduler 52, and the task manager 48 of the second quantum computing system 18, and the qubit registry 28, the quantum services 40, the quantum communication channels 56, the scheduler 58, and the task manager 54 of the third quantum computing system 22.

In one example, the quantum service gateway 12 can provide the client computing device 60 with access to the subset of resources available 84 on the second quantum computing system 18 via the interface 90 when the first segment 64(1) of the quantum instruction file 62 is executed on the second quantum computing system 18 to utilize the subset of resources available 84 on the second quantum computing system 18. In another example, the quantum service gateway 12 can provide the client computing device 60 with access to the subset of resources available 86 on the third quantum computing system 22 via the interface 90 when the second segment 64(2) of the quantum instruction file 62 is executed on the third quantum computing system 22 to utilize the subset of resources available 86 on the third quantum computing system 22. In other examples, the quantum service gateway 12, via the interface 90, can provide the client computing device 60 with access to the resources available 76 on the second quantum computing system 18 when the quantum instruction file 62 is executed on the second quantum computing system 18 or the resources available 78 on the third quantum computing system 22 when the quantum instruction file 62 is executed on the third quantum computing system 22.

In some implementations, the second quantum computing system 18 may receive a request for a list of the resources available 76 on the second quantum computing system 18 from the first quantum computing system 14. The second quantum computing system 18 may provide the list of the resources available 76 on the second quantum computing system 18 to the first quantum computing system 14. The second quantum computing system 18 may receive the first segment 64(1) of the quantum instruction file 62 from the first quantum computing system 14. The second quantum computing system 18 can execute the first segment 64(1) of the quantum instruction file 62 to utilize the subset of resources available 84 on the second quantum computing system 18. The second quantum computing system 18 may receive a request for access to one or more of the qubit registry 26, the quantum services 38, the quantum communication channels 50, the scheduler 52, and the task manager 48 of the second quantum computing system 18 from the first quantum computing system 14. The second quantum computing system 18 may provide the first quantum computing system 14 with access to one or more of the qubit registry 26, the quantum services 38, the quantum communication channels 50, the scheduler 52, and the task manager 48 of the second quantum computing system 18.

For example, the second quantum computing system 18 may provide the first quantum computing system 14 with access to the task manager 48 of the second quantum computing system 18 in order to execute the quantum instruction file 62 or the first segment 64(1) of the quantum instruction file 62 on the second quantum computing system 18. In another example, the second quantum computing system 18 may provide the first quantum computing system 14 with access to the task manager 48 of the second quantum computing system 18 when the client computing device 60 uses the interface 90 in order to run a quantum service and access the subset of resources available 84 on the second quantum computing system 18 via the representative quantum computing system 82(0)-82(N).

It is to be understood that, because the quantum service gateway 12 is a component of the quantum computing device 10, functionality implemented by the quantum service gateway 12 may be attributed to the quantum computing device 10 generally. Moreover, in examples where the quantum service gateway 12 comprises software instructions that program the processor device to carry out functionality discussed herein, functionality implemented by the quantum service gateway 12 may be attributed herein to the processor device. It is to be further understood that while, for purposes of illustration only, the quantum service gateway 12 is depicted as a single component, the functionality implemented by the quantum service gateway 12 may be implemented in any number of components, and the examples discussed herein are not limited to any particular number of components.

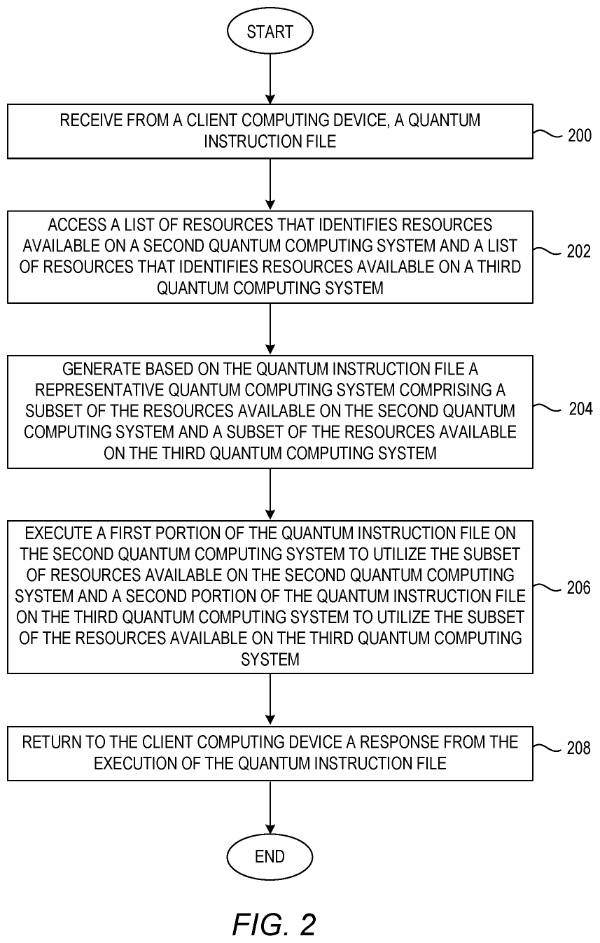

To illustrate exemplary operations performed by the quantum computing device 10 of FIG. 1 for quantum system view via gateway mechanisms for executing quantum services according to one example, FIG. 2 provides a flowchart. Elements of FIG. 1 are referenced in describing FIG. 2 for the sake of clarity. In FIG. 2, operations begin with a processor device of a computing device, such as a processor device of the quantum computing device 10 of FIG. 1, receiving from a client computing device 60 a quantum instruction file 62 (block 200). The processor device then accesses a list of resources that identifies resources available 76 on a second quantum computing system 18 and a list of resources that identifies resources available 78 on a third quantum computing system 22 (block 202). The processor device then generates based on the quantum instruction file 62 a representative quantum computing system 82(0) comprising a subset of the resources available 84 on the second quantum computing system 18 and a subset of the resources available 86 on the third quantum computing system 22 (block 204). The processor device then executes a first portion 64(1) of the quantum instruction file 62 on the second quantum computing system 18 to utilize the subset of resources available 84 on the second quantum computing system 18 and a second portion 64(2) of the quantum instruction file 62 on the third quantum computing system 22 to utilize the subset of the resources available 86 on the third quantum computing system 22 (block 206). The processor device then returns to the client computing device 60 a response 88 from the execution of the quantum instruction file 62 (block 208).

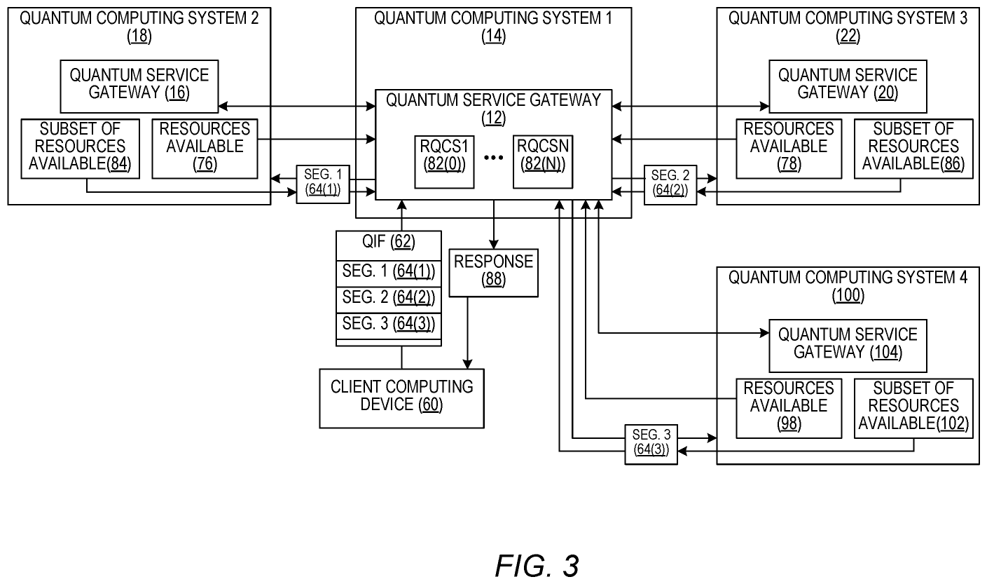

FIG. 3 is a simpler block diagram of the quantum computing device of FIG. 1 for quantum system view via gateway mechanisms, according to one example. Elements of FIG. 1 are referenced in describing FIG. 3 for the sake of clarity. In the example of FIG. 3, the quantum service gateway 12 may receive a list of resources available 98 from a fourth quantum computing system 100. The quantum service gateway 12 may generate the representative quantum computing system 82(0) based on the quantum instruction file 62. The representative quantum computing system 82(0) may comprise the subset of resources available 84 on the second quantum computing system 18, the subset of resources available 86 on the third quantum computing system 22, and a subset of resources available 102 on the fourth quantum computing system 100. The quantum instruction file 62 may contain segments of instructions to be executed on a quantum computing device in a quantum computing system, such as the first segment 64(1), the second segment 64(2), and a third segment 64(3). The quantum service gateway 12 may execute the third segment 64(3) of the quantum instruction file 62 on the fourth quantum computing system 100 to utilize the subset of resources available 102 on the fourth quantum computing system 100. The quantum service gateway 12 may return the response 88 from the execution of the quantum instruction file 62 to the client computing device 60.

The fourth quantum computing system 100 may include a quantum service gateway 104. The quantum service gateway 104 can communicate with the quantum service gateway 12 on the first quantum computing system 14.

The list of resources available 98 on the fourth quantum computing system 100 may comprise computing resources, such as a quantity of qubits, quantum services, quantum communication channels, and API routes, as non-limiting examples, of the fourth quantum computing system 100 that are available for use by the client computing device 60. In some examples, the computing resources in the list of resources available 98 on the fourth quantum computing system 100 may correspond to the computing resources in the list of instructions in the quantum instruction file 62 that includes information about the computing resources required for the client computing device 60 to run in a quantum computing system (e.g., 14, 18, 22, 100). The subset of the resources available 102 on the fourth quantum computing system 100 that comprise the representative quantum computing system 82(0) may include computing resources in the list of instructions in the quantum instruction file 62. For example, the subset of the resources available 102 on the fourth quantum computing system 100 may correspond to the computing resources identified in the third segment 64(3) of the quantum instruction file 62. In some examples, the quantum service gateway 12 can execute the list of instructions in the quantum instruction file 62 on the fourth quantum computing system 100 to utilize the resources available 98 or the subset of resources available 102 on the fourth quantum computing system 100.

The client computing device 60 may be unaware of which quantum computing system (e.g., 14, 18, 22, 100) the computing resources utilized reside on. For example, the client computing device 60 may be unaware of the execution of the first segment 64(1) of the quantum instruction file 62 on the second quantum computing system 18 to utilize the subset of resources available 84 on the second quantum computing system 18, the execution of the second segment 64(2) of the quantum instruction file 62 on the third quantum computing system 22 to utilize the subset of resources available 86 on the third quantum computing system 22, and the execution of the third segment 64(3) of the quantum instruction file 62 on the fourth quantum computing system 100 to utilize the subset of resources available 102 on the fourth quantum computing system 100. In examples where the quantum service gateway 12 executes the list of instructions in the quantum instruction file 62 on the fourth quantum computing system 100 to utilize the resources available 98 or the subset of resources available 102 on the fourth quantum computing system 100, the client computing device 60 may be unaware that the quantum instruction file 62 was executed on the fourth quantum computing system 100 to utilize the resources available 98 or the subset of resources available 102 on the fourth quantum computing system 100.

The quantum service gateway 12 may access one or more of a qubit registry, quantum services, quantum communication channels, a scheduler, and a task manager of the fourth quantum computing system 100. For example, when the quantum service gateway 12 executes the third segment 64(3) of the quantum instruction file 62 on the fourth quantum computing system 100 to utilize the subset of resources available 102 on the fourth quantum computing system 100, the quantum service gateway 12 may access the task manager of the fourth quantum computing system 100. The quantum service gateway 12 can provide the client computing device 60 with access to the subset of resources available 102 on the fourth quantum computing system 100 via the interface 90 when the third segment 64(3) of the quantum instruction file 62 is executed on the fourth quantum computing system 100 to utilize the subset of resources available 102 on the fourth quantum computing system 100. In other examples, the quantum service gateway 12, via the interface 90, can provide the client computing device 60 with access to the resources available 98 on the fourth quantum computing system 100 when the quantum instruction file 62 is executed on the fourth quantum computing system 100.

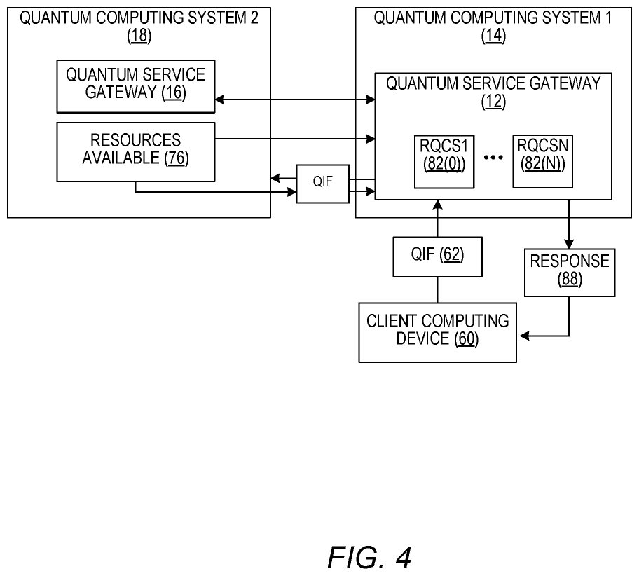

FIG. 4 is a simpler block diagram of the quantum computing device of FIG. 1 for quantum system view via gateway mechanisms, according to one example. Elements of FIG. 1 are referenced in describing FIG. 4 for the sake of clarity. In the example of FIG. 4, the quantum service gateway 12 may generate the representative quantum computing system 82(0). The representative quantum computing system 82(0) may comprise the resources available 76 on the second quantum computing system 18. The quantum service gateway 12 may execute the quantum instruction file 62 on the second quantum computing system 18 to utilize the resources available 76 on the second quantum computing system 18. The quantum service gateway 12 may return the response 88 from the execution of the quantum instruction file 62 to the client computing device 60. The quantum service gateway 12 may communicate with the quantum service gateway 16 on the second quantum computing system 18. The resources available 76 on the second quantum computing system 18 that comprise the representative quantum computing system 82(0) may include computing resources in the list of instructions in the quantum instruction file 62.

The client computing device 60 may be unaware of which quantum computing system (e.g., 14, 18) the computing resources utilized reside on. For example, the client computing device 60 may be unaware that the quantum instruction file 62 was executed on the second quantum computing system 18 to utilize the resources available 76 on the second quantum computing system 18. The quantum service gateway 12 can provide the client computing device 60 with access to the resources available 76 on the second quantum computing system 18 via the interface 90 when the quantum instruction file 62 is executed on the second quantum computing system 18 to utilize the resources available 76 on the second quantum computing system 18.

The quantum service gateway 12 may access one or more of the qubit registry 26, the quantum services 38, the quantum communication channels 50, the scheduler 52, and the task manager 48 of the second quantum computing system 18. For example, when the quantum service gateway 12 executes the quantum instruction file 62 on the second quantum computing system 18 to utilize the resources available 76 on the second quantum computing system 18, the quantum service gateway 12 may access the scheduler 52 and the task manager 48 of the second quantum computing system 18 to assign the resources available 76 or to start or stop one or more quantum services of the quantum services 38.

In other implementations, the second quantum computing system 18 may receive the quantum instruction file 62 from the first quantum computing system 14, and the second quantum computing system 18 may execute the quantum instruction file 62 to utilize the resources available 76 on the second quantum computing system 18.

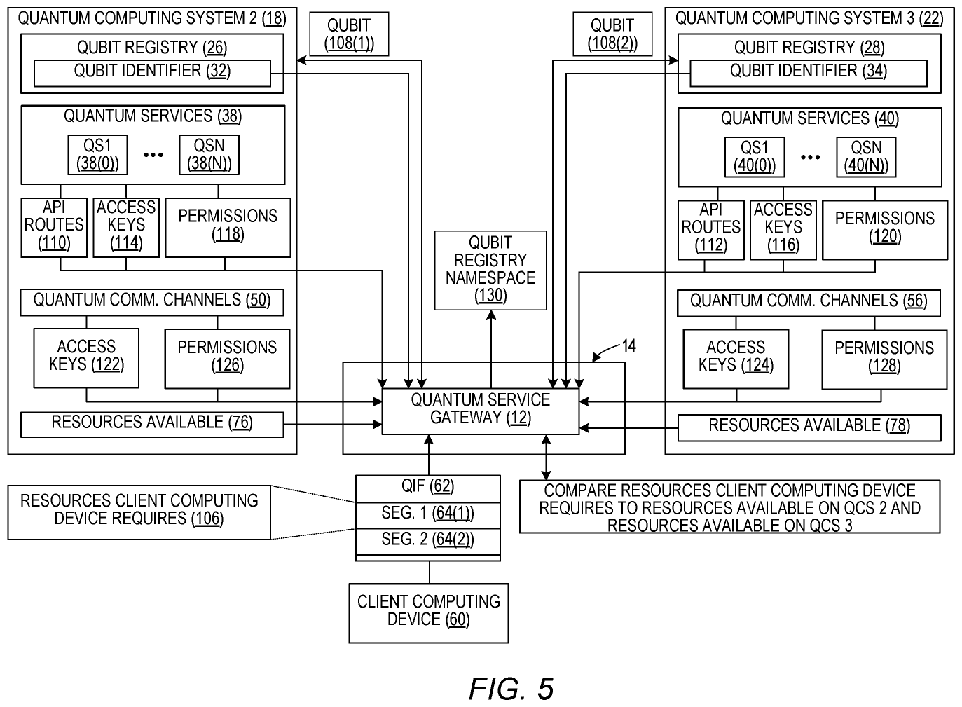

FIG. 5 is a simpler block diagram of the quantum computing device of FIG. 1 for quantum system view via gateway mechanisms, according to one example. Elements of FIG. 1 are referenced in describing FIG. 5 for the sake of clarity. In the example of FIG. 5, the quantum service gateway 12 may identify resources that the client computing device requires 106 in order to run on a quantum computing system (e.g., 14, 18, 22) by reading the quantum instruction file 62. For example, the quantum service gateway 12 may read the first segment 64(1) of the quantum instruction file 62 to identify resources that the client computing device requires 106 in order to run on a quantum computing system (e.g., 14, 18, 22). The quantum service gateway may also read the second segment 64(2) of the quantum instruction file 62 to identify resources that the client computing device requires 106 in order to run on a quantum computing system (e.g., 14, 18, 22). The quantum service gateway 12 may read the list of resources available 76 on the second quantum computing system 18 and the list of resources available 78 on the third quantum computing system 22. The quantum service gateway can compare the resources that the client computing device requires 106 to run on a quantum computing system (e.g., 14, 18, 22) to the list of resources available 76 on the second quantum computing system 18 and the list of resources available 78 on the third quantum computing system 22. The quantum service gateway 12 may determine resources from among the list of resources available 76 on the second quantum computing system 18 and the list of resources available 78 on the third quantum computing system 22 that allow the client computing device 60 to run.

The quantum service gateway 12 may request an available qubit 108(1) from the qubit registry 26 of the second quantum computing system 18 and an available qubit 108(2) from the qubit registry 28 of the third quantum computing system 22. The quantum service gateway 12 may receive the qubit identifier 32 that identifies the available qubit 108(1) from the qubit registry 26 of the second quantum computing system 18 and the qubit identifier 34 that identifies the available qubit 108(2) from the qubit registry 28 of the third quantum computing system 22. The quantum service gateway 12 may obtain API routes 110 to the quantum services 38 that the client computing device 60 requires to run from the second quantum computing system 18. The quantum service gateway 12 may obtain API routes 112 to the quantum services 40 that the client computing device 60 requires to run from the third quantum computing system 22. The quantum service gateway 12 may obtain access keys 114 to utilize the quantum services 38 from the second quantum computing system 18 and access keys 116 to utilize the quantum services 40 from the third quantum computing system 22. The quantum service gateway 12 may obtain permissions 118 to utilize the quantum services 38 from the second quantum computing system 18 and permissions 120 to utilize the quantum services 40 from the third quantum computing system 22. The quantum service gateway 12 may obtain access keys 122 to utilize the quantum communication channels 50 from the second quantum computing system 18 and access keys 124 to utilize the quantum communication channels 56 from the third quantum computing system 22. The quantum service gateway 12 may obtain permissions 126 to utilize the quantum communication channels 50 from the second quantum computing system 18 and permissions 128 to utilize the quantum communication channels 56 from the third quantum computing system 22. The quantum service gateway 12 can create a qubit registry namespace 130 that represents the representative quantum computing system 82(0)-82(N) and qubits of the representative quantum computing system 82(0)-82(N).

In other implementations, the second quantum computing system 18 may receive a request for the available qubit 108(1) from the qubit registry 26 of the second quantum computing system 18 from the first quantum computing system 14. The second quantum computing system 18 may receive the qubit identifier 32 that identifies the available qubit 108(1) from the qubit registry 26. The second quantum computing system 18 may provide the qubit identifier 32 to the first quantum computing system 14. The second quantum computing system 18 may receive from the first quantum computing system 14 a request for one or more of the API routes 110 to the quantum services 38 of the second quantum computing system 18, the access keys 114 to utilize the quantum services 38, the permissions 118 to utilize the quantum services 38, the access keys 122 to utilize the quantum communication channels 50, and the permissions 126 to utilize the quantum communication channels 50 of the second quantum computing system 18. The second quantum computing system 18 may provide to the first quantum computing system 14 one or more of the API routes 110 to the quantum services 38 of the second quantum computing system 18, the access keys 114 to utilize the quantum services 38, the permissions 118 to utilize the quantum services 38, the access keys 122 to utilize the quantum communication channels 50, and the permissions 126 to utilize the quantum communication channels 50 of the second quantum computing system 18.

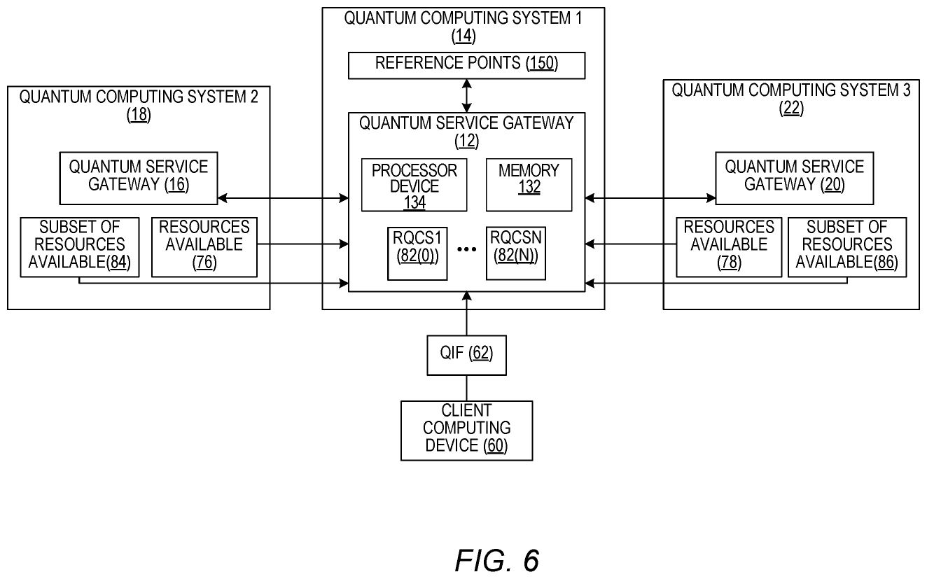

FIG. 6 is a simpler block diagram of the quantum computing device of FIG. 1 for quantum system view via gateway mechanisms, according to one example. Elements of FIG. 1 are referenced in describing FIG. 6 for the sake of clarity. In the example of FIG. 6, the quantum computing device 10 comprises a memory 132 and a processor device 134 coupled to the memory 132. The processor device 134 is to receive a quantum instruction file 62 from a client computing device 60. The processor device 134 is further to communicate with quantum computing devices in other quantum computing systems (e.g., 18, 22). The processor device 134 is further to generate a representative quantum computing system 82(0) comprising a subset of resources available (e.g., 84, 86) on the other quantum computing systems (e.g., 18, 22) based on the quantum instruction file 62. In order to communicate with quantum computing devices in other quantum computing systems (e.g., 18, 22), the processor device 134 is further to access the list of resources that identifies the resources available 76 on the second quantum computing system 18 and the list of resources that identifies the resources available 78 on the third quantum computing system 22. The processor device 134 is further to generate reference points 150 based on the list of resources available 76 on the second quantum computing system 18 and the list of resources available 78 on the third quantum computing system 22. For example, the reference points 150 may indicate that the second quantum computing system 18 has particular computing resources, then the quantum service gateway 12 may receive the information from the quantum service gateway 16 that the second quantum computing system 18 has the particular computing resources and bypass the quantum service gateway 16 when a subsequent request is received from the client computing device 60 to go directly to the task manager 48 and the scheduler 52 of the second quantum computing system 18.

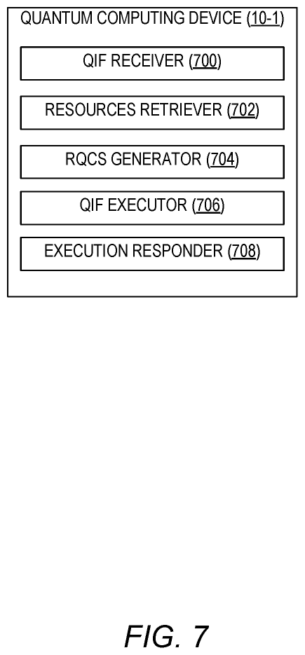

FIG. 7 is a block diagram of a quantum computing device 10-1 according to one example. The quantum computing device 10-1 implements identical functionality as that described above with regard to the quantum computing device 10. The quantum computing device 10-1 includes a quantum instruction file receiver 700 that receives, from a client computing device, a quantum instruction file. The quantum instruction file receiver 700 may comprise executable software instructions configured to program a processor device to implement the functionality of receiving, from a client computing device, a quantum instruction file including, by way of non-limiting example, an application-specific integrated circuit (ASIC), field-programmable gate array (FPGA), or may comprise a combination of executable software instructions and circuitry.

The quantum computing device 10-1 also includes a resources retriever 702 that accesses a list of resources that identifies resources available on a second quantum computing system and a list of resources that identifies resources available on a third quantum computing system. The resources retriever 702 may comprise executable software instructions configured to program a processor device to implement the functionality of accessing a list of resources that identifies resources available, may comprise circuitry including, by way of non-limiting example, an ASIC, FPGA, or may comprise a combination of executable software instructions and circuitry.

The quantum computing device 10-1 also includes a representative quantum computing system generator 704 that generates, based on the quantum instruction file, a representative quantum computing system comprising a subset of the resources available on the second quantum computing system and a subset of the resources available on the third quantum computing system. In some implementations, the representative quantum computing system generator 704 may generate the representative quantum computing system by identifying resources that the client computing device requires to run on a quantum computing system by reading the quantum instruction file, reading the list of resources available on the second quantum computing system and the third quantum computing system, comparing the resources that the client computing device requires to run to the list of resources available on the second quantum computing system and the list of resources available on the third quantum computing system, and determining resources of the resources available on the second quantum computing system and resources of the resources available on the third quantum computing system that allow the client computing device to run. The representative quantum computing system generator 704 may comprise executable software instructions configured to program a processor device to implement the functionality of generating a representative quantum computing system, may comprise circuitry including, by way of non-limiting example, an ASIC, FPGA, or may comprise a combination of executable software instructions and circuitry.

The quantum computing device 10-1 also includes a quantum instruction file executor 706 that executes a first portion of the quantum instruction file on the second quantum computing system to utilize the subset of the resources available on the second quantum computing system and a second portion of the quantum instruction file on the third quantum computing system to utilize the subset of the resources available on the third quantum computing system. The quantum instruction file executor 706 may comprise executable software instructions configured to program a processor device to implement the functionality of executing portions of a quantum instruction file, may comprise circuitry including, by way of non-limiting example, an ASIC, FPGA, or may comprise a combination of executable software instructions and circuitry.

The quantum computing device 10-1 also includes an execution responder 708 that returns, to the client computing device, a response from the execution of the quantum instruction file. The execution responder 708 may comprise executable software instructions configured to program a processor device to implement the functionality of returning a response, may comprise circuitry including, by way of non-limiting example, an ASIC, FPGA, or may comprise a combination of executable software instructions and circuitry.

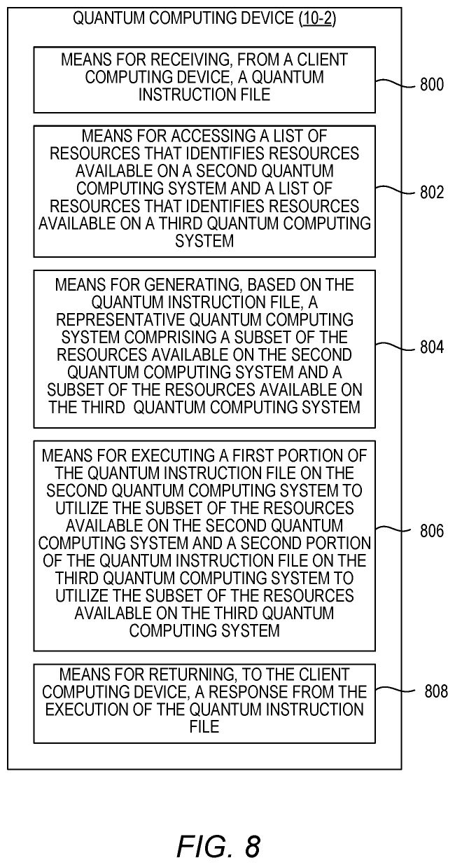

FIG. 8 is a block diagram of the quantum computing device 10 according to additional examples. The quantum computing device 10-2 implements identical functionality as that described above with regard to the quantum computing device 10. In this example, the quantum computing device 10-2 includes a means 800 for receiving, from a client computing device, a quantum instruction file. The means 800 may be implemented in any number of manners, including, for example, via the quantum instruction file receiver 700 illustrated in FIG. 7.

The quantum computing device 10-2 also includes a means 802 for accessing a list of resources that identifies resources available on a second quantum computing system and a list of resources that identifies resources available on a third quantum computing system. The means 802 may be implemented in any number of manners, including, for example, via the resources retriever 702 illustrated in FIG. 7.

The quantum computing device 10-2 also includes a means 804 for generating, based on the quantum instruction file, a representative quantum computing system comprising a subset of the resources available on the second quantum computing system and a subset of the resources available on the third quantum computing system. The means 804 may be implemented in any number of manners, including, for example, via the representative quantum computing system generator 704 illustrated in FIG. 7. The means 804 may, in some implementations, identify resources that the client computing device requires to run on a quantum computing system by reading the quantum instruction file, read the list of resources available on the second quantum computing system and the third quantum computing system, compare the resources that the client computing device requires to run to the list of resources available on the second quantum computing system and the list of resources available on the third quantum computing system, and determine resources of the resources available on the second quantum computing system and resources of the resources available on the third quantum computing system that allow the client computing device to run.

The quantum computing device 10-2 also includes a means 806 for executing a first portion of the quantum instruction file on the second quantum computing system to utilize the subset of the resources available on the second quantum computing system and a second portion of the quantum instruction file on the third quantum computing system to utilize the subset of the resources available on the third quantum computing system. The means 806 may be implemented in any number of manners, including, for example, via the quantum instruction file executor 706 illustrated in FIG. 7.

The quantum computing device 10-2 also includes a means 808 for returning, to the client computing device, a response from the execution of the quantum instruction file. The means 808 may be implemented in any number of manners, including, for example, via the execution responder 708 illustrated in FIG. 7.

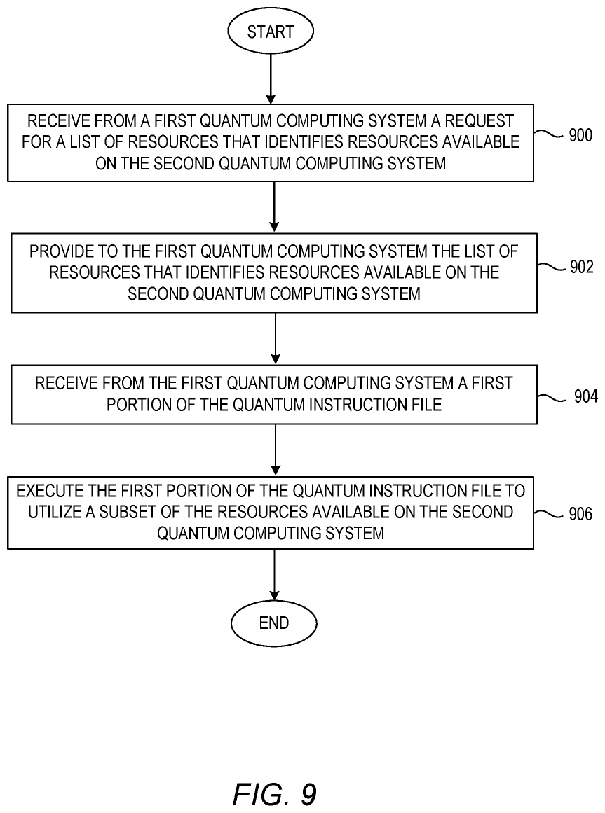

FIG. 9 is a flowchart illustrating operations performed by the quantum computing device of FIG. 1 for quantum system view via gateway mechanisms, according to one example. Elements of FIG. 1 are referenced in describing FIG. 9 for the sake of clarity. In FIG. 9, operations begin with a processor device of a quantum computing device, such as the processor device of the quantum computing device 10 of FIG. 1, receiving from a first quantum computing system 14 a request for a list of resources that identifies resources available 76 on the second quantum computing system 18 (block 900). The processor device then provides to the first quantum computing system 14 the list of resources that identifies resources available 76 on the second quantum computing system 18 (block 902). The processor device then receives from the first quantum computing system 14 a first portion 64(1) of the quantum instruction file 62 (block 904). The processor device then executes the first portion 64(1) of the quantum instruction file 62 to utilize a subset of the resources available 84 on the second quantum computing system 18 (block 906).

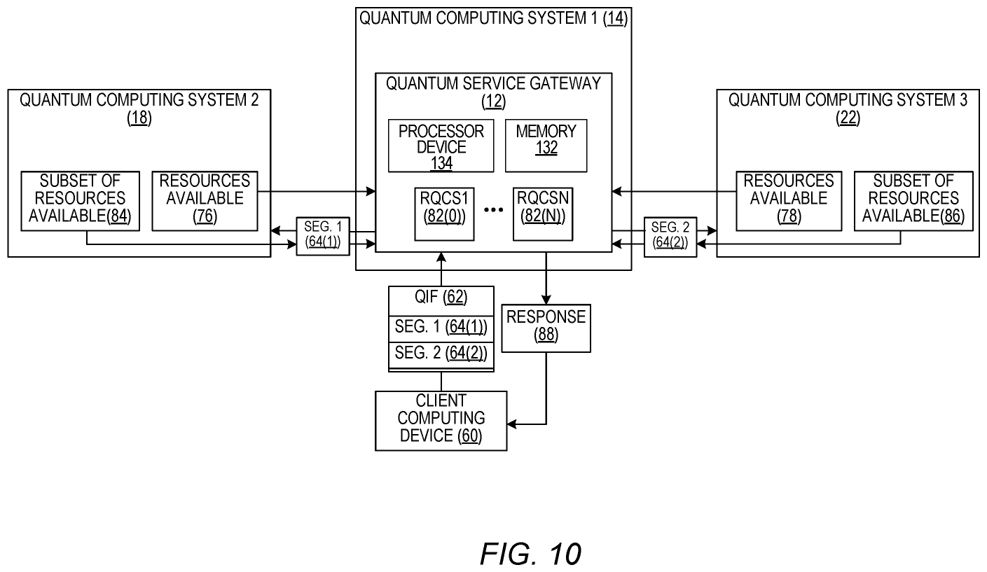

FIG. 10 is a simpler block diagram of the quantum computing device 10 of FIG. 1 for quantum system view via gateway mechanisms, according to one example. Elements of FIG. 1 are referenced in describing FIG. 10 for the sake of clarity. In the example of FIG. 10, the quantum computing device 10 comprises a memory 132 and a processor device 134 coupled to the memory 132. The processor device 134 is to receive a quantum instruction file 62 from a client computing device 60. The processor device 134 is further to access a list of resources that identifies resources available 76 on a second quantum computing system 18 and a list of resources that identifies resources available 78 on a third quantum computing system 22. The processor device 134 is further to generate, based on the quantum instruction file 62, a representative quantum computing system 82(0) comprising a subset of the resources available 84 on the second quantum computing system 18 and a subset of the resources available 86 on the third quantum computing system 22. The processor device 134 is further to execute a first portion 64(1) of the quantum instruction file 62 on the second quantum computing system 18 to utilize the subset of the resources available 84 on the second quantum computing system 18 and a second portion 64(2) of the quantum instruction file 62 on the third quantum computing system 22 to utilize the subset of the resources available 86 on the third quantum computing system 22. The processor device 134 is further to return to the client computing device 60 a response 88 from the execution of the quantum instruction file 62.

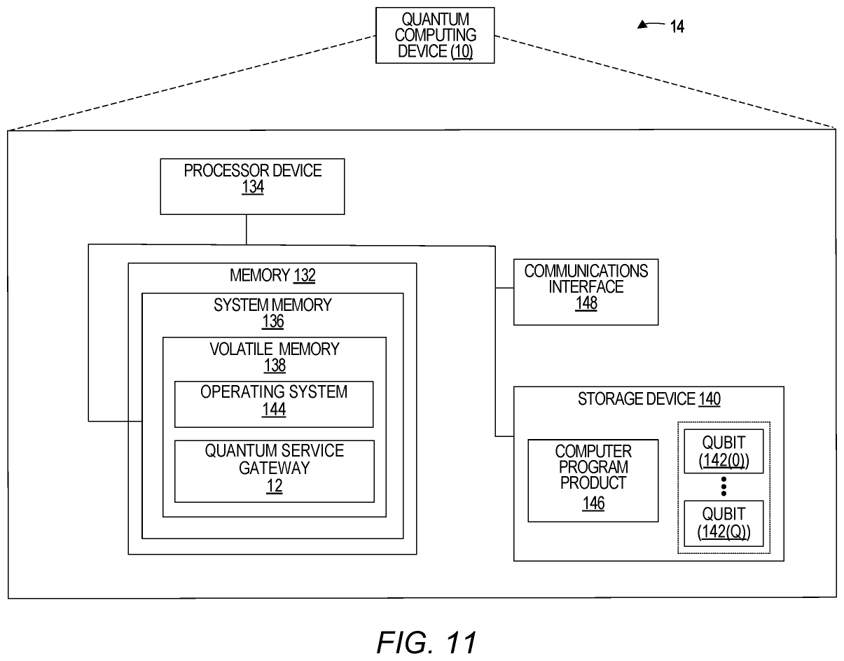

FIG. 11 is a block diagram of a quantum computing device, such as the quantum computing device 10 on the first quantum computing system 14 of FIG. 1, suitable for implementing examples according to one example. Elements of FIG. 1 are referenced in describing FIG. 11 for the sake of clarity. The quantum computing device 10 may comprise any suitable quantum computing device or devices. The quantum computing device 10 can operate using classical computing principles or quantum computing principles. Thus, in some implementations, portions of the quantum computing device 10 (e.g., the quantum service gateway 12) may be executed using classical computing components and/or algorithms. When using quantum computing principles, the quantum computing device 10 performs computations that utilize quantum-mechanical phenomena, such as superposition and entanglement. The quantum computing device 10 may operate under certain environmental conditions, such as at or near zero degrees(0°) Kelvin. When using classical computing principles, the quantum computing device 84 utilizes binary digits that have a value of either zero (0) or one (1).

The quantum computing device 10 includes a processor device 134 and a memory 132. The processor device 134 can be any commercially available or proprietary processor suitable for operating in a quantum environment. The memory 132 may include system memory 136. The system memory 136 may include volatile memory 138 (e.g., random-access memory (RAM)).

The quantum computing device 10 may further include or be coupled to a non-transitory computer-readable medium such as a storage device 140. The storage device 140 may comprise, for example, an internal or external hard disk drive (HDD) (e.g., enhanced integrated drive electronics (EIDE) or serial advanced technology attachment (SATA)) for storage, memory, or the like. The storage device 140 and other drives associated with computer-readable media and computer-usable media may provide non-volatile storage of data, data structures, computer-executable instructions, and the like. The storage device may also provide functionality for storing one or more qubits 142(0)-142(Q).

A number of modules can be stored in the storage device 140 and in the volatile memory 138, including an operating system 144 and one or more modules, such as the quantum service gateway 12. All or a portion of the examples may be implemented as a computer program product 146 stored on a transitory or non-transitory computer-usable or computer-readable medium, such as the storage device 140, which includes complex programming instructions, such as complex computer-readable program code, to cause the processor device 134 to carry out the steps described herein. Thus, the computer-readable program code can comprise computer-executable instructions for implementing the functionality of the examples described herein when executed on the processor device 134.

An operator may also be able to enter one or more configuration commands through a keyboard (not illustrated), a pointing device such as a mouse (not illustrated), or a touch-sensitive surface such as a display device (not illustrated). The quantum computing device 10 may also include a communications interface 148 suitable for communicating with other quantum computing systems, including, in some implementations, classical computing devices.

Other quantum computer system designs and configurations may also be suitable to implement the systems and methods described herein. The following examples illustrate various implementations in accordance with one or more aspects of the disclosure.

Example 1 is a method comprising receiving, by a second quantum computing system from a first quantum computing system, a request for a list of resources that identifies resources available on the second quantum computing system; providing, by the second quantum computing system to the first quantum computing system, the list of resources that identifies resources available on the second quantum computing system; receiving, by the second quantum computing system from the first quantum computing system, a first portion of a quantum instruction file; and executing, by the second quantum computing system, the first portion of the quantum instruction file to utilize a subset of the resources available on the second quantum computing system.

Example 2 is the method of example 1 wherein the list of resources that identifies the resources available on the second quantum computing system comprises resources that allow a client computing device to run.

Example 3 is the method of example 1 further comprising receiving, by the second quantum computing system from the first quantum computing system, the quantum instruction file; and executing, by the second quantum computing system, the quantum instruction file to utilize the resources available on the second quantum computing system.

Example 4 is the method of example 1 further comprising receiving, by the second quantum computing system from the first quantum computing system, a request for access to one or more of a qubit registry, quantum services, quantum communication channels, a scheduler, and a task manager of the second quantum computing system; and providing, by the second quantum computing system to the first quantum computing system, access to one or more of the qubit registry, the quantum services, the quantum communication channels, the scheduler, and the task manager of the second quantum computing system.

Example 5 is the method of example 1 further comprising receiving, by the second quantum computing system from the first quantum computing system, a request for an available qubit from a qubit registry of the second quantum computing system; receiving, by the second quantum system from the qubit registry, a qubit identifier identifying an available qubit; and providing, by the second quantum computing system to the first quantum computing system, the qubit identifier.

Example 6 is the method of example 1 further comprising receiving, by the second quantum computing system from the first quantum computing system, a request for one or more of API routes to quantum services of the second quantum computing system, access keys to utilize the quantum services, permissions to utilize the quantum services, access keys to utilize quantum communication channels, and permissions to utilize quantum communication channels of the second quantum computing system; and providing, by the second quantum computing system to the first quantum computing system, one or more of the API routes to quantum services, the access keys to utilize the quantum services, the permissions to utilize the quantum services, the access keys to utilize quantum communication channels, and the permissions to utilize quantum communication channels of the second quantum computing system.

Example 7 is a quantum computing device that includes a memory and a processor device coupled to the memory. The processor device is to receive, from a first quantum computing system, a request for a list of resources that identifies resources available on the second quantum computing system; provide, to the first quantum computing system, the list of resources that identifies resources available on the second quantum computing system; receive, from the first quantum computing system, a first portion of a quantum instruction file; and execute the first portion of the quantum instruction file to utilize a subset of the resources available on the second quantum computing system.

Example 8 is the quantum computing device of example 7 wherein the list of resources that identifies the resources available on the second quantum computing system comprises resources that allow a client computing device to run.

Example 9 is the quantum computing device of example 7 wherein the processor device is further to receive from the first quantum computing system, the quantum instruction file; and execute the quantum instruction file to utilize a subset of the resources available on the second quantum computing system.

Example 10 is the quantum computing device of example 7 wherein the processor device is further to receive, from the first quantum computing system, a request for access to one or more of a qubit registry, quantum services, quantum communication channels, a scheduler, and a task manager of the second quantum computing system; and provide, to the first quantum computing system, access to one or more of the qubit registry, the quantum services, the quantum communication channels, the scheduler, and the task manager of the second quantum computing system.

Example 11 is the quantum computing device of example 7 wherein the processor device is further to receive, from the first quantum computing system, a request for an available qubit from a qubit registry of the second quantum computing system; receive, from the qubit registry, a qubit identifier identifying an available qubit; and provide, to the first quantum computing system, the qubit identifier.

Example 12 is the quantum computing device of example 7 wherein the processor device is further to receive, from the first quantum computing system, a request for one or more of API routes to quantum services of the second quantum computing system, access keys to utilize the quantum services, permissions to utilize the quantum services, access keys to utilize quantum communication channels, and permissions to utilize quantum communication channels of the second quantum computing system; and provide, to the first quantum computing system, one or more of the API routes to quantum services, the access keys to utilize the quantum services, the permissions to utilize the quantum services, the access keys to utilize quantum communication channels, and the permissions to utilize quantum communication channels of the second quantum computing system.

Example 13 is a non-transitory computer-readable storage medium that includes computer-executable instructions that, when executed, cause one or more processor devices to receive, from a first quantum computing system, a request for a list of resources that identifies resources available on the second quantum computing system; provide, to the first quantum computing system, the list of resources that identifies resources available on the second quantum computing system; receive, from the first quantum computing system, a first portion of a quantum instruction file; and execute the first portion of the quantum instruction file to utilize a subset of the resources available on the second quantum computing system.

Example 14 is the non-transitory computer-readable storage medium of example 13 wherein the list of resources that identifies the resources available on the second quantum computing system comprises resources that allow a client computing device to run.

Example 15 is the non-transitory computer-readable storage medium of example 13 wherein the instructions are further to cause the processor device to receive from the first quantum computing system, the quantum instruction file; and execute the quantum instruction file to utilize a subset of the resources available on the second quantum computing system.

Example 16 is the non-transitory computer-readable storage medium of example 13 wherein the instructions are further to cause the processor device to receive, from the first quantum computing system, a request for access to one or more of a qubit registry, quantum services, quantum communication channels, a scheduler, and a task manager of the second quantum computing system; and provide, to the first quantum computing system, access to one or more of the qubit registry, the quantum services, the quantum communication channels, the scheduler, and the task manager of the second quantum computing system.

Example 17 is the non-transitory computer-readable storage medium of example 13 wherein the instructions are further to cause the processor device to receive, from the first quantum computing system, a request for an available qubit from a qubit registry of the second quantum computing system; receive, from the qubit registry, a qubit identifier identifying an available qubit; and provide, to the first quantum computing system, the qubit identifier.

Example 18 is the non-transitory computer-readable storage medium of example 13 wherein the instructions are further to cause the processor device to receive, from the first quantum computing system, a request for one or more of API routes to quantum services of the second quantum computing system, access keys to utilize the quantum services, permissions to utilize the quantum services, access keys to utilize quantum communication channels, and permissions to utilize quantum communication channels of the second quantum computing system; and provide, to the first quantum computing system, one or more of the API routes to quantum services, the access keys to utilize the quantum services, the permissions to utilize the quantum services, the access keys to utilize quantum communication channels, and the permissions to utilize quantum communication channels of the second quantum computing system.

Example 19 is a quantum computing device that includes a quantum instruction file receiver to receive, from a client computing device, a quantum instruction file; a resources retriever to access a list of resources that identifies resources available on a second quantum computing system and a list of resources that identifies resources available on a third quantum computing system; a representative quantum computing system generator to generate, based on the quantum instruction file, a representative quantum computing system comprising a subset of the resources available on the second quantum computing system and a subset of the resources available on the third quantum computing system; a quantum instruction file executor to execute a first portion of the quantum instruction file on the second quantum computing system to utilize the subset of the resources available on the second quantum computing system and a second portion of the quantum instruction file on the third quantum computing system to utilize the subset of the resources available on the third quantum computing system; and an execution responder to return, to the client computing device, a response from the execution of the quantum instruction file.

Example 20 is a quantum computing device that includes a means for receiving, from a client computing device, a quantum instruction file; a means for accessing a list of resources that identifies resources available on a second quantum computing system and a list of resources that identifies resources available on a third quantum computing system; a means for generating, based on the quantum instruction file, a representative quantum computing system comprising a subset of the resources available on the second quantum computing system and a subset of the resources available on the third quantum computing system; a means for executing a first portion of the quantum instruction file on the second quantum computing system to utilize the subset of the resources available on the second quantum computing system and a second portion of the quantum instruction file on the third quantum computing system to utilize the subset of the resources available on the third quantum computing system; and a means for returning, to the client computing device, a response from the execution of the quantum instruction file.

Individuals will recognize improvements and modifications to the preferred examples of the disclosure. All such improvements and modifications are considered within the scope of the concepts disclosed herein and the claims that follow.

What is claimed is:

1. A method comprising:
receiving, by a first quantum computing system from a client computing device, a quantum instruction file;
accessing, by the first quantum computing system, a list of resources that identifies resources available on a second quantum computing system and a list of resources that identifies resources available on a third quantum computing system;
generating, by the first quantum computing system based on the quantum instruction file, a representative quantum computing system comprising a subset of the resources available on the second quantum computing system and a subset of the resources available on the third quantum computing system;
executing, by the first quantum computing system, a first portion of the quantum instruction file on the second quantum computing system to utilize the subset of the resources available on the second quantum computing system and a second portion of the quantum instruction file on the third quantum computing system to utilize the subset of the resources available on the third quantum computing system; and
returning, by the first quantum computing system to the client computing device, a response from the execution of the quantum instruction file.

2. The method of claim 1, further comprising:
receiving, by the first quantum computing system from a fourth quantum computing system, a list of resources available on the fourth quantum computing system;
generating, by the first quantum computing system, a representative quantum computing system comprising the subset of the resources available on the second quantum computing system, the subset of the resources available on the third quantum computing system, and a subset of the resources available on the fourth quantum computing system based on the quantum instruction file;
executing, by the first quantum computing system, a third portion of the quantum instruction file on the fourth quantum computing system to utilize the subset of the resources available on the fourth quantum computing system; and
returning, by the first quantum computing system to the client computing device, a response from the execution of the quantum instruction file.

3. The method of claim 1, further comprising:
generating, by the first quantum computing system, a representative quantum computing system comprising the resources available on the second quantum computing system;
executing, by the first quantum computing system, the quantum instruction file on the second quantum computing system to utilize the resources available on the second quantum computing system; and
returning, by the first quantum computing system to the client computing device, a response from the execution of the quantum instruction file.

4. The method of claim 1, wherein the first quantum computing system is in a different location from the second quantum computing system and the third quantum computing system.

5. The method of claim 1, wherein the second quantum computing system is in a different location from the first quantum computing system and the third quantum computing system.

6. The method of claim 1, wherein the client computing device is unaware of executing the first portion of the quantum instruction file on the second quantum computing system to utilize the subset of the resources available on the second quantum computing system and the second portion of the quantum instruction file on the third quantum computing system to utilize the subset of the resources available on the third quantum computing system.

7. The method of claim 1, wherein the quantum instruction file comprises a list of instructions to be executed on a quantum computing system.

8. The method of claim 7, wherein the instructions comprise one or more of a quantity of qubits, quantum services, quantum communication channels, and API routes that the client computing device requires to run on a quantum computing system.

9. The method of claim 7, wherein one or more of the instructions are predefined for a qubit in the second quantum computing system.

10. The method of claim 7, wherein the list of instructions comprises segments of instructions to be executed together on a quantum computing system.

11. The method of claim 1, wherein generating the representative quantum computing system comprising the subset of the resources available on the second quantum computing system and the subset of the resources available on the third quantum computing system based on the quantum instruction file comprises:
identifying resources that the client computing device requires to run on a quantum computing system by reading the quantum instruction file;
reading the list of resources available on the second quantum computing system;
reading the list of resources available on the third quantum computing system;
comparing the resources that the client computing device requires to run to the list of resources available on the second quantum computing system and the list of resources available on the third quantum computing system; and
determining resources of the resources available on the second quantum computing system and resources of the resources available on the third quantum computing system that allow the client computing device to run.

12. The method of claim 11, further comprising:
requesting, from a qubit registry of the second quantum computing system, an available qubit;
requesting, from a qubit registry of the third quantum computing system, an available qubit;
obtaining, from the second quantum computing system and the third quantum computing system, API routes to quantum services that the client computing device requires to run;
obtaining, from the second quantum computing system and the third quantum computing system, one or more of access keys and permissions to utilize the quantum services;
obtaining, from the second quantum computing system and the third quantum computing system, one or more of access keys and permissions to utilize quantum communication channels; and
creating a qubit registry namespace, wherein the qubit registry namespace represents the representative quantum computing system and qubits of the representative quantum computing system.

13. The method of claim 1, further comprising:
providing the client computing device with access to the subset of the resources available on the second quantum computing system and the subset of the resources available on the third quantum computing system comprising the representative quantum computing system through an interface to the representative quantum computing system.

14. The method of claim 13, wherein the interface to the representative quantum computing system comprises one or more of an application programming interface (API), a configuration file, and an interface contract.

15. The method of claim 13, further comprising:
subsequent to returning, by the first quantum computing system to the client computing device, a response from executing the quantum instruction file, utilizing the interface to run a quantum service via the representative quantum computing system.

16. The method of claim 1, further comprising:
accessing, by the first quantum computing system, one or more of a qubit registry, quantum services, quantum communication channels, a scheduler, and a task manager of the second quantum computing system.

17. The method of claim 1, further comprising:
accessing, by the first quantum computing system, one or more of a qubit registry, quantum services, quantum communication channels, a scheduler, and a task manager of the third quantum computing system.

18. A quantum computing device, comprising:
a memory; and
a processor device coupled to the memory, the processor device to:
receive a quantum instruction file from a client computing device;
communicate with quantum computing devices in other quantum computing systems; and
generate a representative quantum computing system comprising a subset of resources available on the other quantum computing systems based on the quantum instruction file.

19. The quantum computing device of claim 18, wherein to communicate with quantum computing devices in other quantum computing systems, the processor device is further to:
access a list of resources that identifies resources available on a second quantum computing system and a list of resources that identifies resources available on a third quantum computing system, wherein the second quantum computing system and the third quantum computing system are from among the other quantum computing systems; and
generate reference points based on the list of resources available on the second quantum computing system and the list of resources available on the third quantum computing system.

20. A non-transitory computer-readable storage medium that includes computer-executable instructions that, when executed, cause one or more processor devices to:
receive a quantum instruction file from a client computing device;
access a list of resources that identifies resources available on a second quantum computing system and a list of resources that identifies resources available on a third quantum computing system; and
generate a representative quantum computing system comprising a subset of the resources available on the second quantum computing system and a subset of the resources available on the third quantum computing system.
